(19) United States
(12) Patent Application Publication
(10) Pub. No.: US 2013/0084238 A1
(43) Pub. Date: Apr. 4, 2013

(54) METHOD OF MAKING NANOMATERIAL AND METHOD OF FABRICATING SECONDARY BATTERY USING THE SAME

(71) Applicant: UNIST Academy-Industry Research Corporation, Ulsan (KR)

(72) Inventors: Soo-Jin Park, Ulsan (KR); Jung-In Lee, Gunpo-si (KR); Hyun-Kon Song, Ulsan (KR); Jae-Phil Cho, Ulsan (KR)

(73) Assignee: UNIST Academy-Industry Research Corporation, Ulsan (KR)

(21) Appl. No.: 13/671,654

(22) Filed: Nov. 8, 2012

(30) Foreign Application Priority Data
May 12, 2010 (KR) 10-2010-0044582

(51) Int. Cl. C01G 3/02; B22F 9/24

(52) U.S. Cl. CPC C01G 3/02; B22F 9/24; Y10S 977/90; Y10S 977/896; B82Y 40/00
USPC 423/604; 75/370; 75/369; 977/900; 977/896

(57) ABSTRACT

Disclosed are a method of making a nanomaterial and a method of fabricating a lithium secondary battery using the same. The method of making a nanomaterial includes preparing a mixed solution including a metal salt aqueous solution and an alkylamine, and hydrothermally treating the mixed solution.

### CROSS-REFERENCE TO RELATED APPLICATION

This application claims priority to and the benefit of Korean Patent Application No. 10-2010-0044582 filed in the Korean Intellectual Property Office on May 12, 2010, the entire contents of which are incorporated herein by reference. In addition, the entire contents of PCT/KR2010/003142 are incorporated herein by reference.

### BACKGROUND OF THE INVENTION

(a) Field of the Invention

A method of making a nanomaterial and a method of fabricating a secondary battery using the same are disclosed.

(b) Description of the Related Art

A nanomaterial is a material having a diameter of several to hundreds of nanometers. The nanomaterial has different physical, chemical, and electrical characteristics from a conventional material having a size of more than or equal to a micrometer, and thus is researched as an alternative capable of overcoming the limits of the conventional material.

The nanomaterial may be applied to, for example, various regions such as electronic equipment, optical equipment, a catalyst, a chemical sensor, and the like. Accordingly, development of various nanomaterials is actively researched.

### SUMMARY OF THE INVENTION

An easily-controlled method of making a nanomaterial is provided.

A method of fabricating a secondary battery using the method of making a nanomaterial is provided.

According to one aspect of the present invention, a method of making a nanomaterial is provided, which includes preparing a mixed solution including a metal salt and an alkylamine and hydrothermally treating the mixed solution.

According to another aspect of the present invention, a method of preparing a negative active material for a lithium secondary battery, which includes preparing a mixed solution including a metal salt and an alkylamine, hydrothermally treating the mixed solution to form a nanomaterial, and heat-treating the nanomaterial.

The metal salt may include a copper salt, a nickel salt, a lead salt, or a combination thereof.

The metal salt may include chloride, sulfate, nitrate, or a combination thereof.

The metal salt may include copper chloride (CuCl₂), copper sulfate (CuSO₄), or a combination thereof.

The metal salt and the alkylamine in the mixed solution are present at a mole ratio of 15:2.

The alkylamine may include a compound represented by the following Chemical Formula 1, a compound represented by the following Chemical Formula 2, or a combination thereof.

CH₃(CH₂)ₘNH₂ [Chemical Formula 1]

NH₂(CH₂)ₙNH₂ [Chemical Formula 2]

In the above Chemical Formula 1, m is an integer ranging from 7 to 20, and in the above Chemical Formula 2, n is an integer ranging from 4 to 20.

The alkylamine may include decylamine, dodecylamine, tetradecylamine, hexadecylamine, octadecylamine, or a combination thereof.

The hydrothermal treatment may be performed under an inert gas atmosphere.

The hydrothermal treatment may be performed at a temperature ranging from about 100° C. to about 300° C.

The hydrothermally-treated nanomaterial may be further washed.

The washed nanomaterial may be further heat-treated under an oxygen atmosphere.

Accordingly, the present invention provides an easily-controlled method of making a nanomaterial. The method may provide a nanomaterial having desired characteristics. This nanomaterial is used to fabricate a secondary battery having improved characteristics.

### BRIEF DESCRIPTION OF THE DRAWINGS

FIGS. 1 to 5 are scanning electron microscope (SEM) photographs showing a nanomaterial according to Example 1.

FIGS. 6 to 8 are scanning electron microscope (SEM) photographs showing a nanomaterial according to Example 2.

FIGS. 9 to 11 are transmission electron microscope photographs showing a nanomaterial according to Example 3.

FIGS. 12 and 13 are transmission electron microscope photographs showing the nanomaterial according to Example 3.

FIGS. 14 and 15 are XRD diffraction patterns showing the nanomaterial according to Example 3.

### DETAILED DESCRIPTION OF THE EMBODIMENTS

Hereinafter, a method of preparing a nanowire according to embodiments and a method of fabricating a lithium secondary battery using the nanowire are described. The embodiments are provided so that a person having ordinary skill in the art may easily understand the spirit of the present invention, and the present invention is not limited thereto. The embodiments may be modified within technical spirits and scopes of the present invention.

As used herein, the term “and/or” may refer to one including at least one of listed constituent elements. As used herein, each constituent element and/or part may be described using “first and second”, which is used for clear explanation without limitation.

As used herein, one constituent element “on” another constituent element further includes positioning a third constituent element on the one constituent element as well as directly positioning the one constituent element on the other constituent element.

In addition, the thickness and/or relative thickness of the constituent elements are exaggerated for better understanding and easy description of embodiments of the present invention. Furthermore, terms related to a position such as “upper”, “lower”, and the like in this specification are used to indicate relative positions rather than absolute positions among the constituent elements.

Method of Making a Nanomaterial

Hereinafter, a method of making a nanomaterial is described.

First, a metal salt solution including a metal salt is prepared. The metal salt solution may be prepared by dissolving a compound including a metal salt in a solvent.

The metal salt may include, for example, a copper salt, a nickel salt, a lead salt, or a combination thereof. The metal salt may include, for example, a chloride, a sulfate, a nitrate, or a combination thereof. Specific examples of the metal salts may include copper chloride (CuCl₂) and copper sulfate (CuSo₄).

For example, the solvent may be water. Thereby, the aqueous solution including the metal salt may be prepared. According to one embodiment of the present invention, the metal salt solution may include a metal salt in a concentration ranging from about 1 mM to about 100 mM.

The metal salt solution includes an alkylamine. For example, the metal salt solution may include a compound represented by the following Chemical Formula 1 or 2 or a combination thereof.

CH₃(CH₂)ₘNH₂ [Chemical Formula 1]

NH₂(CH₂)ₙNH₂ [Chemical Formula 2]

In the above Chemical Formula 1, m is an integer ranging from 7 to 20, and n is an integer ranging from 4 to 20.

The alkylamine may include, for example, decylamine (CH₃(CH₂)₉NH₂), dodecylamine (CH₃(CH₂)₁₁NH₂), tetradecylamine (CH₃(CH₂)₁₃NH₂), hexadecylamine (CH₃(CH₂)₁₅NH₂), octadecylamine (CH₃(CH₂)₁₇NH₂), or a combination thereof.

The alkylamine may be included in a liquid or solution state. The alkylamine relative to the metal salt may have a mole ratio of about 1:15 to about 1:3. For example, the alkylamine relative to the metal salt may have a mole ratio of about 2:15. When the alkylamine and the metal salt are included in a mole ratio of about 2:15, a nanomaterial having an appropriate size may be prepared in a high yield rate. The alkylamine may be included, for example, in a concentration of about 0.2 mM to about 20 mM in the mixed solution.

The alkylamine includes an alkyl group, whose length and concentration determine properties of nanomaterials. For example, the longer the alkyl group the alkylamine has, the thinner is the nanomaterial formed. According to another embodiment of the present invention, when the alkylamine is included in a higher concentration, a thinner nanomaterial is formed. In other words, characteristics of a nanomaterial according to embodiments of the present invention may be easily controlled by adjusting the alkylamine.

The mixed solution may be agitated at a temperature ranging from about 60° C. to about 120° C. for about 3 to about 7 hours.

Then, the mixed solution may be heated. For example, the mixed solution is put in an autoclave, and the autoclave is put in an oven to heat the mixed solution therein. The heat treatment may cause a hydrothermal reaction between the metal salt and the alkylamine in the mixed solution.

The hydrothermal reaction may be performed at a temperature ranging from about 100° C. to about 300° C. The hydrothermal reaction may be performed for about 12 hours to about 72 hours. The hydrothermal reaction may be performed under an inert gas atmosphere, for example, a nitrogen (N₂) or argon (Ar) atmosphere.

After the hydrothermal reaction, the mixed solution may be cooled. The mixed solution may be cooled to room temperature or less than or equal to a lower temperature than room temperature. Specifically, the mixed solution may be cooled to room temperature.

The cooled mixed solution is filtered, obtaining a nanomaterial. The nanomaterial may have a diameter of several to hundreds of nanometers. According to one embodiment of the present invention, the nanomaterial may be a nanowire. The nanomaterial may have various sizes and shapes depending on various reaction conditions such as kinds of an alkylamine, the concentration and reaction time of the alkylamine, and the like. For example, the nanomaterial may have a diameter ranging from about 2 nm to about 40 nm.

The nanomaterial may be washed. The nanomaterial may be simultaneously or sequentially washed by an organic solvent and/or an inorganic solvent. For example, the nanomaterial may be rinsed and washed by dodecane, n-hexane, ethanol, and distilled water. The washing may remove impurities.

According to one embodiment of the present invention, the nanomaterial may be selectively heat-treated. During the heat treatment, the nanomaterial may be provided with air. The nanomaterial may react with a part of the components included in air, for example, oxygen. Accordingly, the nanomaterial may be oxidized.

The heat treatment may be performed at a temperature ranging from about 300° C. to about 650° C. for about 30 minutes to about 3 hours. The nanomaterial may be sufficiently oxidized within the temperature range and become stable.

The oxidation may increase the diameter of the nanomaterial. The oxidized nanomaterial may have a diameter of about 1.2 times to about twice that of the nanomaterial before the heat treatment.

For example, when the oxidized nanomaterial is applied to a negative active material for a secondary battery, the oxidized nanomaterial may have an average diameter ranging from about 5 nm to about 50 nm. The oxidized nanomaterial having a diameter within the range may accomplish excellent capacity and cycle-life characteristics of the secondary battery.

The heat treatment may transform the physical shape of the nanomaterial. For example, the heat treatment may transform a nanowire into a nanotube.

The heat treatment may be selectively performed depending on characteristics of a desired material.

Method of Preparing Negative Active Material for Lithium Secondary Battery Using Nanomaterial

The aforementioned method of forming a nanomaterial may be applied to a method of fabricating a lithium secondary battery. For example, a nanomaterial prepared in the method of making a nanomaterial may be applied to a method of preparing a negative active material for a lithium secondary battery.

According to one embodiment of the present invention, the method of making a nanomaterial may form copper nanowires. The copper nanowires may be heat-treated and thus transformed into copper nanotubes. The copper nanotubes may be mixed with a conductive agent. Alternatively, the copper nanotubes may be coated with a conductive agent.

The copper nanotubes are mixed with a binder material and thus may form a negative active material layer.

According to the embodiments of the present invention, in the method of making a nanomaterial, characteristics of the nanomaterial may be easily adjusted. For example, a nanomaterial having desired characteristics may be easily formed by adjusting the concentration of a metal salt and/or an alkylamine in the mixed solution and the time and temperature of the heat treatment during the hydrothermal reaction.

Accordingly, the nanomaterial may have physical and electrical characteristics that are appropriate for forming a negative active material for a lithium secondary battery. The nanomaterial is applied to a lithium secondary battery, and may improve various characteristics including charge and discharge capacity.

Hereinafter, the present invention is illustrated in more detail through examples of the present invention. However, the following examples are provided only for explanation and do not limit the range of the present invention.

### Example 1

### Size Control of Nanomaterial by Adjusting Alkylamine

### Examples 1-1 to 1-5

A metal salt aqueous solution was prepared. In the present exemplary embodiment, an about 12.5 mM copper chloride (CuCl₂) aqueous solution was used. About 80 mL of the metal salt aqueous solution was put in each of five containers, and each of decylamine (CH₃(CH₂)₉NH₂), dodecylamine (CH₃(CH₂)₁₁NH₂), tetradecylamine (CH₃(CH₂)₁₅NH₂), hexadecylamine (CH₃(CH₂)₁₅NH₂), and octadecylamine (CH₃(CH₂)₁₇NH₂) were respectively added thereto. The decylamine, dodecylamine, tetradecylamine, hexadecylamine, and octadecylamine were respectively added to have a concentration of about 2 mM.

The mixed solutions were agitated at about 80° C. for about 5 hours. Then, the mixed solutions were put in an autoclave, and the autoclave was put in an about 200° C. oven and reacted for about 48 hours.

The reaction may be represented by, for example, the following Reaction Scheme 1.

RNH₂→RNH+½H_{2(g)}

Cu²⁺+H₂(g)→Cu⁽⁰⁾+2H⁺ (reduction step)

RNH₂+H⁺→RNH³⁺ [Reaction Scheme 1]

In the reaction scheme 1, R is an alkyl group of alkylamine, CH₃(CH₂)ₘ, or NH₂(CH₂)ₙ. m is an integer ranging from 7 to 20, and n is an integer ranging from 4 to 20.

After the reaction, a product was cooled to room temperature. The product was copper nanowires. The copper nanowires were sequentially washed with dodecane, n-hexane, ethanol, and distilled water.

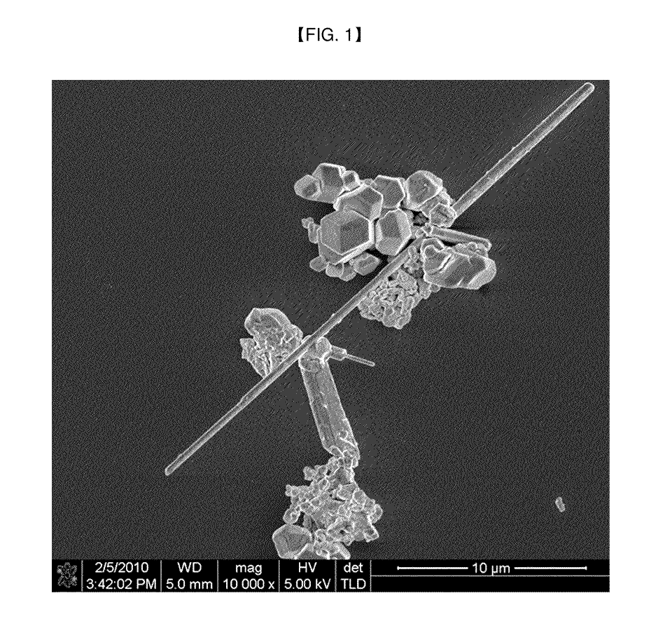

FIGS. 1 to 5 are scanning electron microscope (SEM) photographs showing the copper nanowires according to Examples 1-1 to 1-5.

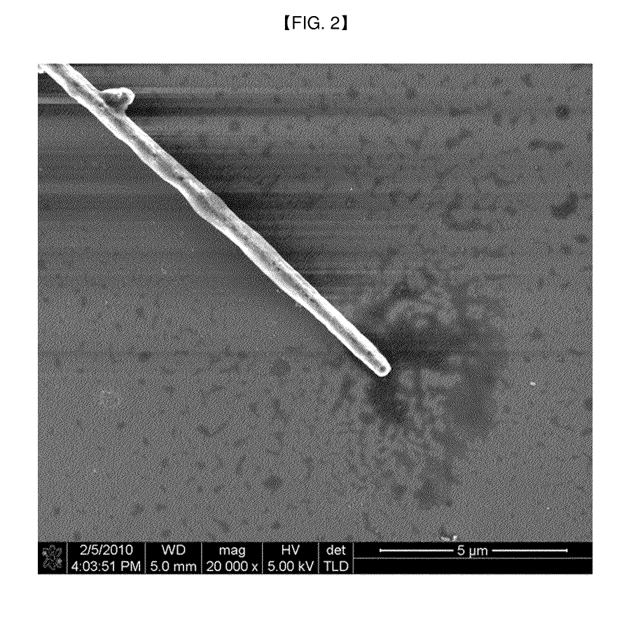

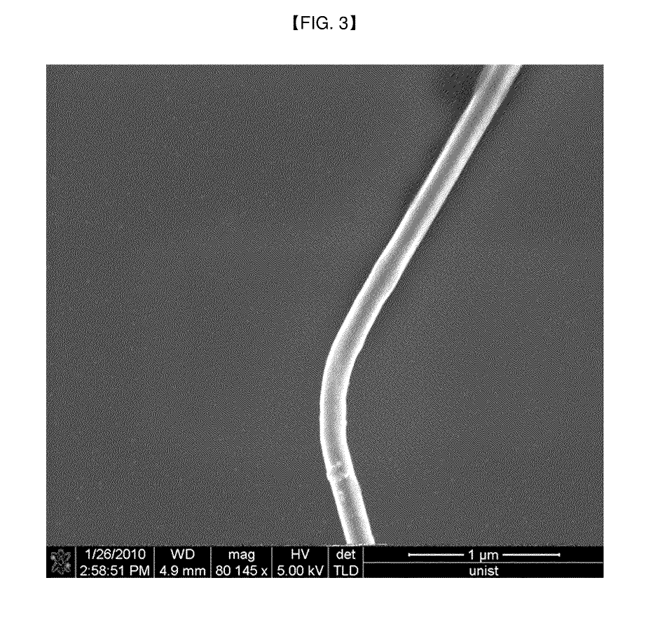

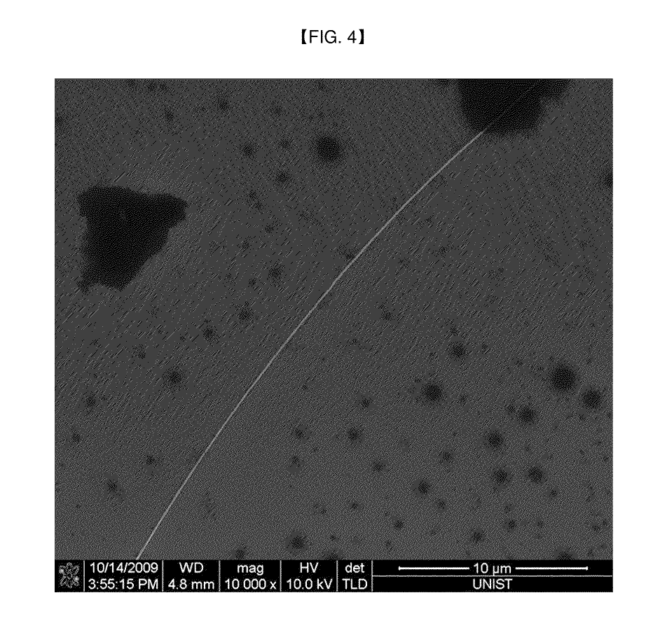

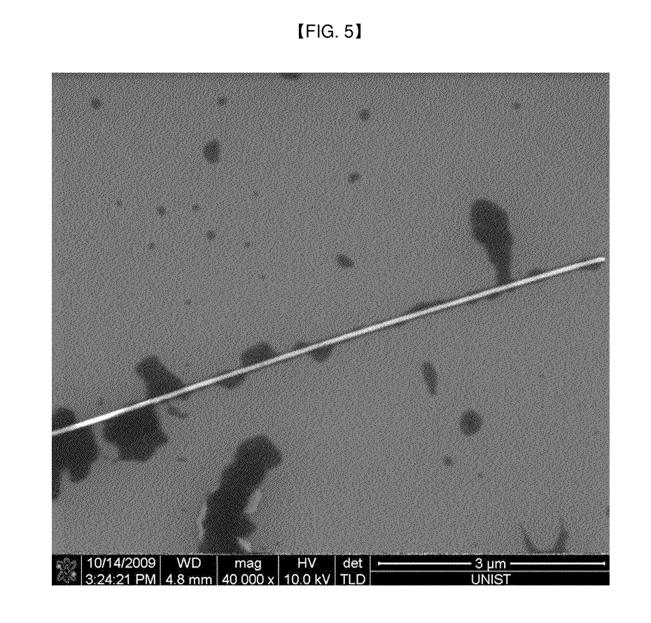

FIG. 1 is a scanning electron microscope showing the copper nanowires synthesized using decylamine according to Example 1-1, FIG. 2 is a scanning electron microscope showing the copper nanowires synthesized using dodecylamine according to Example 1-2, FIG. 3 is a scanning electron microscope showing the copper nanowires synthesized using tetradecylamine according to Example 1-3, FIG. 4 is a scanning electron microscope showing the copper nanowires synthesized using hexadecylamine according to Example 1-4, and FIG. 5 is a scanning electron microscope showing the copper nanowires synthesized using octadecylamine according to Example 1-5.
Referring to FIGS. 1 to 5, the copper nanowires according to Example 1-1 had an average wire diameter of about 400 nm, the copper nanowires according to Example 1-2 had an average wire diameter of about 200 nm, the copper nanowires according to Example 1-3 had an average wire diameter of about 150 nm, the copper nanowires according to Example 1-4 had an average wire diameter of about 100 nm, and the copper nanowires according to Example 1-5 had an average wire diameter of about 80 nm.

The copper nanowires were controlled regarding thickness and length depending on an alkylamine. In particular, the longer an alkyl group the alkylamine had, the thinner the copper nanowires were formed. In addition, the longer the alkyl group the alkylamine had, the longer the copper nanowires were formed.

In other words, the copper nanowires according to Example 1 might be easily controlled regarding thickness and length by the alkyl group of the alkylamine in the mixed solution.

### Example 2

### Nanomaterial Control by Adjusting Concentration of Alkylamine

### Examples 2-1 to 2-3

A metal salt aqueous solution was prepared. In the present exemplary embodiment, an about 12.5 mM copper chloride (CuCl₂) or copper sulfate (CuSO₄) aqueous solution was used as the metal salt aqueous solution. About 80 mL of the metal salt aqueous solution was put in each of three separate containers, and octadecylamine (CH₃(CH₂)₁₇NH₂) was added thereto. The octadecylamine was added each of them in a concentration of about 1 mM, about 2 mM, and about 4 mM, respectively. The concentrations of the octadecylamine were the concentrations in mixed solutions prepared by adding the octadecylamine to the metal salt aqueous solutions.

The mixed solutions were agitated at about 80° C. for about 5 hours. The agitated mixed solutions were put in an autoclave, and were reacted in an about 160° C. oven for about 72 hours. The reaction was performed under an inert gas atmosphere.

After the reaction, the autoclave was cooled to room temperature. The reaction produced copper nanowires. The produced copper nanowires were washed with dodecane, n-hexane, ethanol, and distilled water.

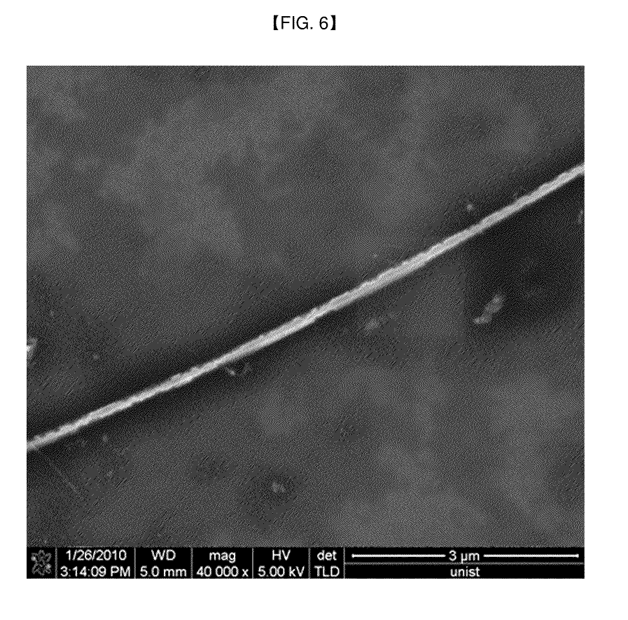

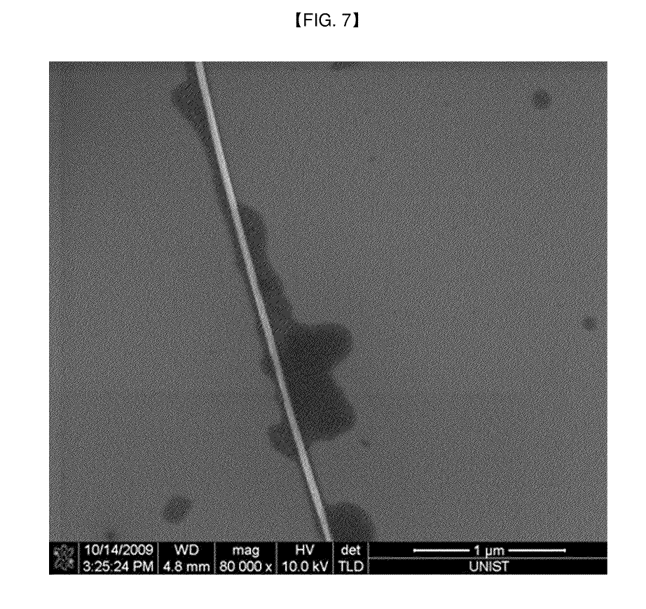

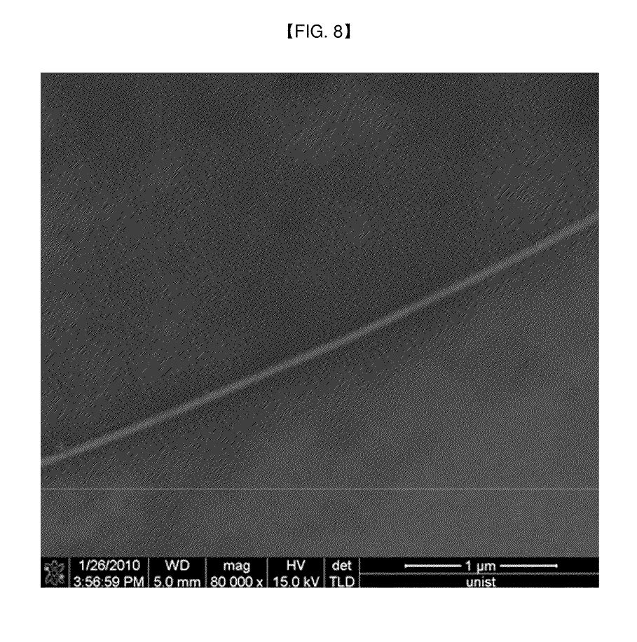

FIG. 6 is a scanning microscope photograph showing the copper nanowires synthesized using about 1 mM of octadecylamine according to Example 2-1, FIG. 7 is a scanning microscope photograph showing the copper nanowires synthesized using about 2 mM of octadecylamine according to Example 2-1, and FIG. 8 is a scanning microscope photograph showing the copper nanowires synthesized using about 1 mM of octadecylamine according to Example 2-3.

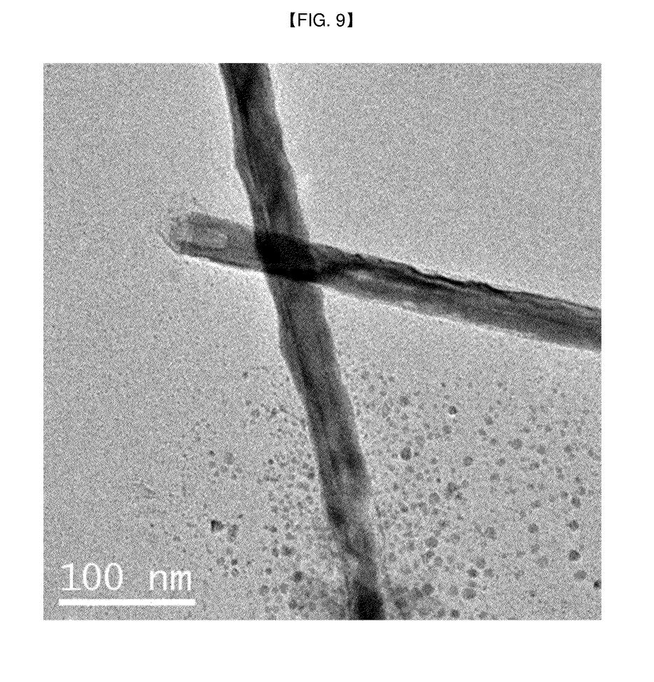

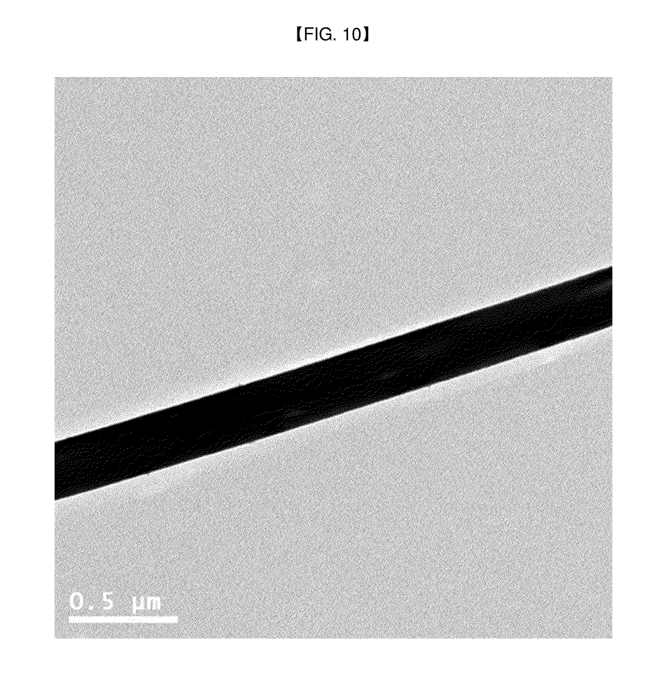

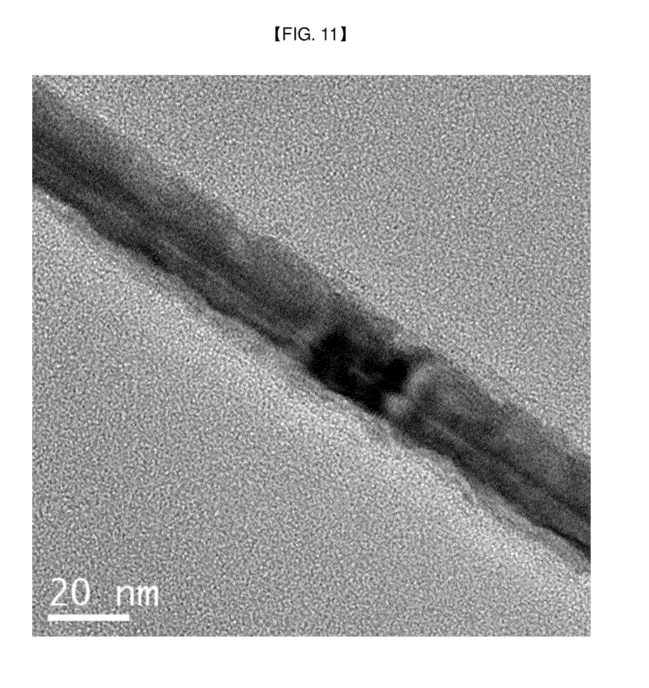

FIG. 9 is a transmission electron microscope photograph showing the copper nanowires according to Example 2-1, FIG. 10 is a transmission electron microscope photograph showing the copper nanowires according to Example 2-2, and FIG. 11 is a transmission electron microscope photograph showing the copper nanowires according to Example 2-3.

Referring to FIGS. 6 to 8 and 9 to 11, when the octadecylamine was respectively included in a concentration of about 1 mM, about 2 mM, and about 4 mM, the copper nanowire respectively had an average thickness of about 200 nm, about 80 nm, and about 35 nm. In other words, the more the alkylamine was included, the thinner the copper nanowires were produced.

In addition, the more the alkylamine was included, the thinner but longer copper nanowires were produced.

In other words, the copper nanowires according to Example 2 were adjusted regarding thickness by controlling the concentration of an alkylamine in the mixed solution.

### Example 3

### Fabrication of Copper Oxide Nanotubes

Copper nanowires were fabricated according to the same method as Example 2-2.

The copper nanowires were heat-treated in an about 400° C. oven for about one hour, while air was continually injected therein. In this way, the copper nanowires were transformed into copper nanotubes.

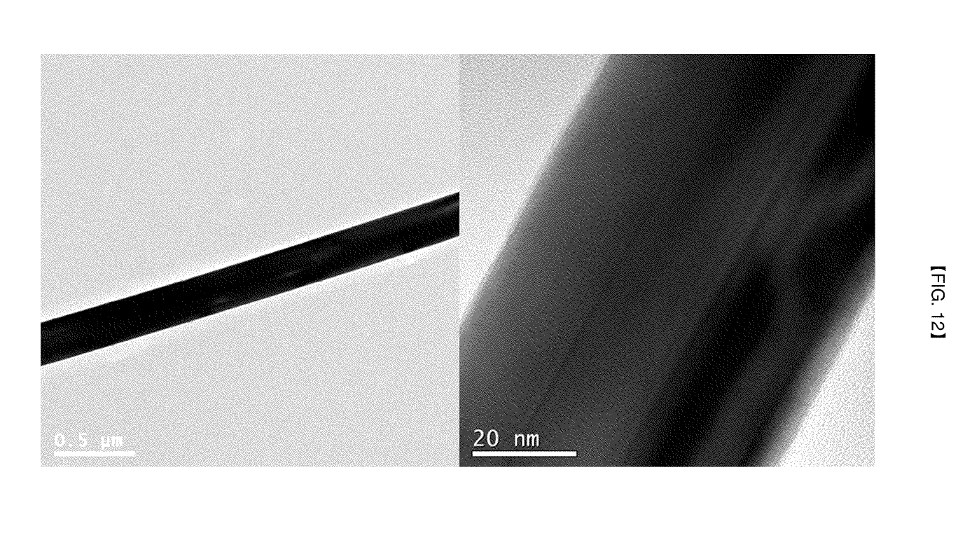

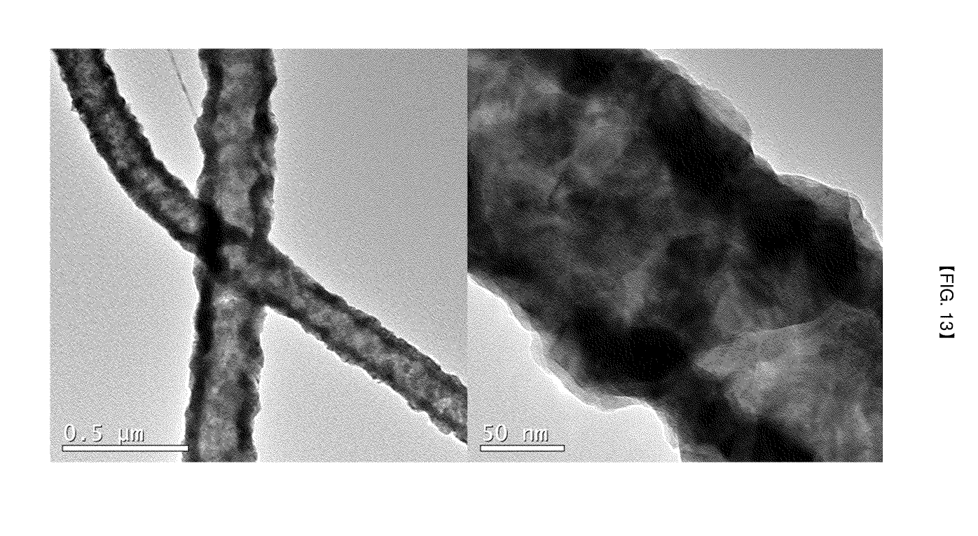

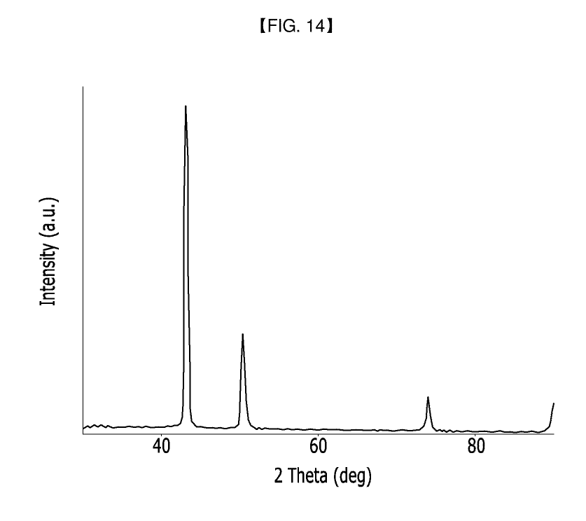

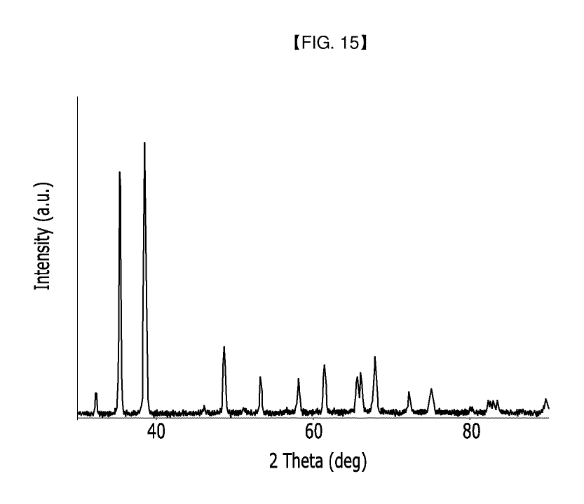

FIG. 12 shows transmission electron microscope photographs taken of the copper nanowires according to Example 2-2 with different enlargements before the following heat treatment, and FIG. 13 shows transmission electron microscope photographs taken of the copper nanowires according to Example 2-2 with different enlargements after the following heat treatment.

FIGS. 12 and 13 respectively show the copper nanowires according to Example 2-2 and the XRD diffraction pattern of the heat-treated copper nanowires. Herein, a CuK-α ray was used as a light source.

Referring to FIGS. 12 and 13, the copper nanowires were turned into copper oxide nanotubes through the heat treatment. The copper nanowires were oxidized by oxygen provided during the heat treatment and transformed into copper oxide nanotubes. The copper oxide nanotubes had about 1.7 times larger diameter than the copper nanowires. The diameter of the copper oxide nanotubes might be adjusted by a heat treatment temperature, a heat treatment time, or a combination thereof.

Hereinbefore, the embodiments of the present invention were illustrated in detail, but do not limit the scope of the present invention. The scope of the present invention includes transformations, modifications, and reformations of the embodiments within the technological spirit thereof.

What is claimed is:

1. A method of making a nanomaterial comprising:
preparing a mixed solution comprising a metal salt aqueous solution and an alkylamine; and
hydrothermally treating the mixed solution.

2. The method of making a nanomaterial of claim 1, wherein the metal salt comprises a chloride, a sulfate, a nitrate, and a combination thereof.

3. The method of making a nanomaterial of claim 1, wherein the metal salt comprises a copper salt, a nickel salt, a lead salt, or a combination thereof.

4. The method of making a nanomaterial of claim 3, wherein the metal salt comprises copper chloride (CuCl₂), copper sulfate (CuSO₄), or a combination thereof.

5. The method of making a nanomaterial of claim 1, wherein the metal salt and the alkylamine in the mixed solution are present in a mole ratio of about 3:1 to about 15:1.

6. The method of making a nanomaterial of claim 1, wherein the alkylamine comprises a compound represented by the following Chemical Formula 1, a compound represented by the following Chemical Formula 2, or a combination thereof:
CH₃(CH₂)ₘNH₂ [Chemical Formula 1]
NH₂(CH₂)ₙNH₂ [Chemical Formula 2]
wherein, in the above Chemical Formula 1, m is an integer ranging from 7 to 20, and in the above Chemical Formula 2, n is an integer ranging from 4 to 20.

7. The method of making a nanomaterial of claim 6, wherein the alkylamine comprises decylamine, dodecylamine, tetradecylamine, hexadecylamine, octadecylamine, or a combination thereof.

8. The method of making a nanomaterial of claim 1, wherein the hydrothermal treatment is performed under an inert gas atmosphere.

9. The method of making a nanomaterial of claim 1, wherein the hydrothermal treatment is performed at 100° C. to 300° C.

10. The method of making a nanomaterial of claim 1, which further comprises washing the hydrothermally-treated nanomaterial.

11. The method of making a nanomaterial of claim 10, wherein the nanomaterial is further heat-treated under an oxygen atmosphere.

12. A method of preparing a negative active material for a lithium secondary battery, comprising:
preparing a mixed solution including a metal salt aqueous solution and an alkylamine;
hydrothermally treating the mixed solution to form a nanomaterial; and
heat-treating the nanomaterial.

13. The method of claim 12, wherein the metal salt is a copper salt, a nickel salt, a lead salt, or a combination thereof.

14. The method of claim 13, wherein the metal salt comprises copper chloride (CuCl₂), copper sulfate (CuSO₄), or a combination thereof.

15. The method of claim 12, wherein the alkylamine comprises a compound represented by the following Chemical Formula 1, a compound represented by the following Chemical Formula 2, or a combination thereof:
CH₃(CH₂)ₘNH₂ [Chemical Formula 1]
NH₂(CH₂)ₙNH₂ [Chemical Formula 2]
wherein, in the above Chemical Formula l, m is an integer ranging from 7 to 20, and in the above Chemical Formula 2, n is an integer ranging from 4 to 20.

16. The method of claim 12, wherein the heat treatment is performed under an oxygen atmosphere.

17. The method of claim 16, wherein the heat treatment is performed at a temperature ranging from about 300° C. to about 650° C. for about 2 hours.

18. The method of claim 12, wherein the nanomaterial is oxidized through the heat treatment.

19. The method of claim 12, wherein the nanomaterial has a diameter that is about 1.2 to about 2 times larger after the heat treatment than before the heat treatment.

20. The method of claim 19, wherein the heat-treated nanomaterial has a diameter ranging from about 5 nm to about 50 nm.
